(19) United States
(12) Patent Application Publication
(10) Pub. No.: US 2025/0286488 A1
(43) Pub. Date: Sep. 11, 2025

(54) CONTROLLER, METHOD, AND NON-TRANSITORY COMPUTER READABLE MEDIUM FOR DRIVE SYSTEM

(71) Applicant: DENSO CORPORATION, Kariya-city (JP)

(72) Inventor: Ryohei OISHI, Kariya-city (JP)

(21) Appl. No.: 19/220,749

(22) Filed: May 28, 2025

Related U.S. Application Data
(63) Continuation of application No. PCT/JP2024/002268, filed on Jan. 25, 2024.

(30) Foreign Application Priority Data
Feb. 22, 2023 (JP) 2023-026477

(51) Int. Cl. H02P 21/22; H02P 21/05; H02P 27/08

(52) U.S. Cl. CPC H02P 21/22; H02P 21/05; H02P 27/08

(57) ABSTRACT

A controller includes a feedback controller and a state feedback controller. The feedback controller performs feedback control using a d-axis current value and a d-axis current command value, and feedback control using a q-axis current value and a q-axis current command value, and calculates a d-axis voltage command value and a q-axis voltage command value. The state feedback controller calculates a d-axis voltage value and a q-axis voltage value, obtained by state feedback control of a d-axis current value and a q-axis current value, by performing rotational conversion at a rotation angle determined by the characteristics of the motor, which is correlated with a rotation speed of a motor using a rotation matrix, to calculate a d-axis voltage correction value and a q-axis voltage correction value.

### CROSS REFERENCE TO RELATED APPLICATIONS

The present application is a continuation application of International Patent Application No. PCT/JP2024/002268 filed on Jan. 25, 2024, which designated the U.S. and claims the benefit of priority from Japanese Patent Application No. 2023-026477 filed on Feb. 22, 2023. The entire disclosures of all of the above applications are incorporated herein by reference.

### TECHNICAL FIELD

The present disclosure relates to a controller, a method, and a non-transitory computer readable medium for a drive system.

### BACKGROUND

A controller may rotate an electric rotating machine. The controller may calculate a feedback manipulated variable for controlling the rotation speed of a motor to which a cooling fan is attached to a target value.

### SUMMARY

The present disclosure describes a controller, a method and a non-transitory computer readable medium, each of which is adapted to a drive system in which an inverter converts DC power of a DC power supply into three-phase AC power and the three-phase AC power is supplied to a rotating electric machine.

### BRIEF DESCRIPTION OF DRAWINGS

FIG. 1 is a block diagram showing a schematic configuration of a drive system.

FIG. 2 is a diagram showing a schematic configuration of a state feedback controller.

FIG. 3 is a diagram showing a schematic configuration of a feedback controller and a state feedback controller according to a modified example.

FIG. 4 is a graph showing the rotation speed characteristics of K_{SFB}.

FIG. 5 is a graph showing the rotation speed characteristics of θ_{SFB}.

FIG. 6 is a graph showing the rotation speed characteristics of K_{FBC}.

FIG. 7 is a graph showing the rotation speed characteristics of θ_{FBC}.

FIG. 8A is an explanatory diagram for explaining effects.

FIG. 8B is an explanatory diagram for explaining effects.

FIG. 9 is a graph showing a torque ripple reduction effect.

### DETAILED DESCRIPTION

A controller may calculate a feedback manipulated variable for controlling the rotation speed of a motor to which a cooling fan is attached to a target value. Further, based on the rotation speed, a load operation amount is calculated, which is a feedforward operation amount equivalent to a load torque that increases as the rotation speed of the motor increases. Then, the inverter is operated based on a command manipulated variable, which is a value obtained by adding a load manipulated variable to a feedback manipulated variable.

Incidentally, in a system including an inverter, harmonic ripples may occur due to variations in the dead time of the inverter. It is conceivable that this dead time variation can be suppressed by state feedback control. However, state feedback control has an issue in that the control period is slow and the control system becomes unstable when the motor rotates at high speed.

A controller described herein is for a drive system in which an inverter converts DC power of a DC power supply into three-phase AC power and the three-phase AC power is supplied to a rotating electric machine. The controller calculates a voltage command to be output to the inverter by performing vector control. The controller includes a command value output unit, a conversion unit, a feedback controller, a state feedback controller, and a control unit. The command value output unit outputs a d-axis current command value and a q-axis current command value. The conversion unit converts phase currents flowing through respective phases of the rotating electric machine into a d-axis current value and a q-axis current value. The feedback controller calculates a d-axis voltage command value and a q-axis voltage command value by performing feedback control based on the d-axis current value and the d-axis current command value, and feedback control based on the q-axis current value and the q-axis current command value. The state feedback controller calculates a d-axis voltage correction value and a q-axis voltage correction value by performing state feedback control of the d-axis current value and the q-axis current value to acquire a d-axis voltage value and a q-axis voltage value, and rotation conversion of the d-axis voltage value and the q-axis voltage value at an angle by using a rotation matrix. The angle is correlated to a rotational speed of the rotatory electric machine and determined based on a characteristics of the rotating electric machine. The control unit outputs to the inverter a value as the voltage command obtained by performing uvw conversion of a d-axis corrected command value and a q-axis corrected command value. The d-axis corrected command value is a value obtained by subtracting the d-axis voltage correction value from either the d-axis voltage command value or a correlated value correlated to the d-axis voltage command value. The q-axis corrected command value is a value obtained by subtracting the q-axis voltage correction value from either the q-axis voltage command value or a correlated value correlated to the q-axis voltage command value.

In this way, the controller uses the rotation matrix to perform rotational conversion at an angle that is correlated with the rotation speed of the rotating electric machine and is determined by the characteristics of the rotating electric machine, and calculates the d-axis voltage correction value and the q-axis voltage correction value. Then, the controller calculates a d-axis corrected command value and a q-axis corrected command value using the d-axis voltage correction value and the q-axis corrected command value, and outputs the uvw converted values of the d-axis corrected command value and the q-axis corrected command value as voltage commands to the inverter. Therefore, the controller can suppress instability caused by state feedback control when the control period is slow and the rotation speed is high. Therefore, the controller can stably control the inverter when the control period is slow and the rotating electric machine rotates at high speed.

An embodiment for carrying out the present disclosure is hereinafter described with reference to the drawings.

In this embodiment, as an example, a drive system 100 is applied to a cooling system. The cooling system includes the drive system 100, a radiator that dissipates heat from the cooling water flowing through an engine (not shown), a cooling fan 50 that air-cools the cooling water flowing through the radiator, and a motor 30 that rotates the cooling fan 50. The radiator is connected to the engine via a cooling water passage (not shown) that includes an inlet flow path and an outlet flow path.

The motor 30 is an AC-driven rotating electric machine having U-, V- and W-phase coils 31, 32 and 33, respectively. The cooling fan 50 is attached to the rotating shaft of the motor 30. The cooling fan 50 is rotated by the motor 30 depending on whether the vehicle is stopped or traveling at a low speed.

The drive system 100 includes a controller 10 and an inverter 20 (INV). The inverter 20 is connected to positive and negative terminals of a battery 70. The inverter 20 is connected to the motor 30 via wirings L1 to L3. The inverter 20 converts the DC power supplied from the battery 70 into three-phase AC power of U, V, and W, and supplies it to the motor 30. The battery 70 corresponds to a DC power supply.

The inverter 20 has a set of series-connected switching elements for each of the U, V, and W-phases, and is configured by connecting the series-connected sets in parallel. The connection points of the switching elements of each phase are connected to the U-, V-, and W-phase coils 31 to 33 of the motor 30 via the wirings L1, L2, and L3. The switching elements are turned on and off by an operation signal (voltage command) output from the controller 10, thereby supplying power to the coils 31 to 33 of each phase via the wirings L1 to L3. The switching element may be, for example, a MOSFET or an IGBT.

A current detection unit 40 is provided on the wirings L1 to L3. The current detection unit 40 includes three phase detection units 41 to 43 that detect the phase currents flowing through the respective phase coils 31 to 33. The U-phase detection unit 41 is provided on the wiring L1 that connects the inverter 20 and the U-phase coil 31. The U-phase detection unit 41 detects the phase current flowing through the U-phase coil 31 as a U-phase current Iu.

The V-phase detection unit 42 is provided on the wiring L2 that connects the inverter 20 and the V-phase coil 32. The V-phase detection unit 42 detects the phase current flowing through the V-phase coil 32 as a V-phase current Iv.

The W-phase detection unit 43 is provided on the wiring L3 that connects the inverter 20 and the W-phase coil 33. The W-phase detection unit 133 detects the current flowing through the W-phase coil of the first winding set 180 as the W-phase current Iw1. The phase currents Iu to Iw are provided to a three-to-two phase conversion unit 15, which will be described later.

In this embodiment, a shunt resistor is used as an example of each of the phase detection units 41 to 43. However, in the present disclosure, Hall ICs or the like can be used as each of the phase detection units 41 to 43.

The motor 30 is provided with a resolver 60 that detects the electrical angle θr of the motor 30. The electrical angle θr is provided to a two-to-three phase conversion unit 13, a three-to-two phase conversion unit 15 and a rotation speed calculation unit 16, which will be described later. The current detection unit 40 and the resolver 60 may be included in the drive system 100.

The controller 10 is a device that calculates an operation signal to be output to the inverter 20 by vector control. The controller 10 mainly includes a microcomputer and a control IC. The controller 10 may include, for example, a processing device such as a CPU, a memory device including a ROM and a RAM, and an interface such as an I/O circuit. The controller 10 executes control by, for example, software recorded in a physical memory device and a computer that executes the software, hardware, or a combination of these components.

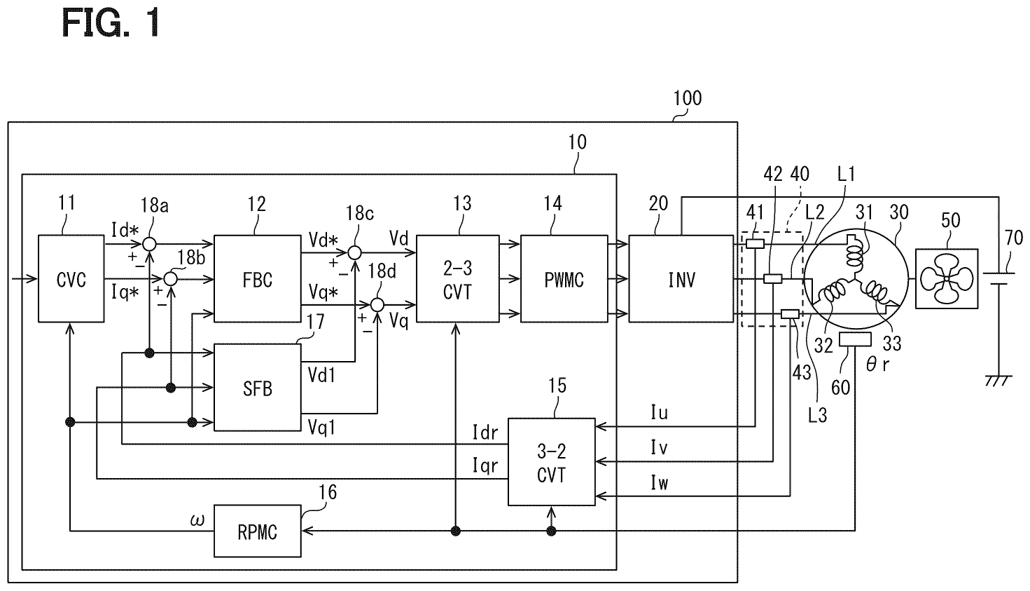

As shown in FIG. 1, the controller 10 includes a command value calculation unit 11, a feedback controller 12, the two-to-three phase conversion unit 13, a PWM control unit 14, the three-to-two phase conversion unit 15, the rotation speed calculation unit 16, and a state feedback controller 17. Furthermore, the controller 10 includes a first d-axis calculator 18a, a first q-axis calculator 18b, a second d-axis calculator 18c, and a second q-axis calculator 18d. In the drawing, the command value calculation unit 11 is indicated as CVC, the feedback controller 12 is indicated as FBC, the two-to-three phase conversion unit 13 is indicated as 2-3CVT, and the PWM control unit 14 is indicated as PWMC. In addition, the three-to-two phase conversion unit 15 is described as a 3-2CVT, the rotation speed calculation unit 16 as an RPMC, and the state feedback controller 17 as an SFB.

The command value calculation unit 11 calculates a feedback manipulated variable based on an externally input command value and the rotation speed w of the motor 30 calculated by the rotation speed calculation unit 16. The command value calculation unit 11 calculates, as feedback manipulated variables, a d-axis current command value Id* and a q-axis current command value Iq*, which are values on the dq coordinate system. The command value calculation unit 11 outputs the calculated d-axis current command value Id* and q-axis current command value Iq*. The command value calculation unit 11 corresponds to a command value output unit.

Here, among the axes defining the d-q coordinates, the d-axis is the axis of the ineffective current component, that is, the exciting current component which is a current contributing to the rotation magnetic field accompanying the rotation of the motor 30. On the other hand, the q-axis is the axis of the active current component, that is, the torque current component which is the current that contributes to the torque of the motor 30.

The feedback controller 12 performs feedback control using a d-axis current value Idr and a d-axis current command value Id*, and also performs feedback control using a q-axis current value Iqr and a q-axis current command value Iq*. In this way, the feedback controller 12 calculates a d-axis voltage command value Vd* and a q-axis voltage command value Vq*. The d-axis current value Idr and the q-axis current value Iqr are output from a three-to-two phase conversion unit 15, which will be described later.

More specifically, the feedback controller 12 receives outputs from a first d-axis calculator 18a, a first q-axis calculator 18b, and the rotation speed calculation unit 16. The first d-axis calculator 18a calculates a d-axis current deviation ΔId by subtracting the d-axis current value Idr from the d-axis current command value Id*. The first q-axis calculator 18b calculates a q-axis current deviation ΔIq by subtracting the q-axis current value Iqr from the q-axis current command value Iq*. The rotation speed calculation unit 16 outputs the rotation speed w of the motor 30, as will be described later. The feedback controller 12 receives the d-axis current deviation ΔId and the q-axis current deviation ΔIq. The feedback controller 12 calculates a d-axis voltage command value Vd* so that the d-axis current deviation ΔId becomes zero, and calculates a q-axis voltage command value Vq* so that the q-axis current deviation ΔIq becomes zero. Then, the feedback controller 12 improves the current response performance by eliminating the interference component using the rotation speed ω.

The two-to-three phase conversion unit 13 receives outputs from a second d-axis calculator 18c and a second q-axis calculator 18d. The second d-axis calculator 18c calculates a value obtained by subtracting the d-axis voltage correction value Vd1 from the d-axis voltage command value Vd* as the d-axis corrected command value Vd. The second q-axis calculator 18d calculates a q-axis corrected command value Vq by subtracting the q-axis voltage correction value Vq1 from the q-axis voltage command value Vq*. The d-axis corrected command value Vd can also be called a d-axis voltage deviation, which is the deviation between the d-axis voltage command value Vd* and the d-axis voltage correction value Vd1. The q-axis corrected command value Vq can also be called a q-axis voltage deviation, which is the deviation between the q-axis voltage command value Vq* and the q-axis voltage correction value Vq1. The d-axis voltage correction value Vd1 and the q-axis voltage correction value Vq1 are output from a state feedback controller 17, which will be described later.

The two-to-three phase conversion unit 13 performs uvw conversion on the d-axis corrected command value Vd and the q-axis corrected command value Vq using the electrical angle θr of the motor 30. That is, the two-to-three phase conversion unit 13 performs uvw conversion on the d-axis corrected command value Vd and the q-axis corrected command value Vq into a U-phase command voltage Vu, a V-phase command voltage Vv, and a W-phase command voltage Vw.

In this manner, the controller 10 corrects the d-axis voltage command value Vd* using the d-axis voltage correction value Vd1 calculated by the state feedback controller 17. In addition, the controller 10 corrects the q-axis voltage command value Vq* using the q-axis voltage correction value Vq1 calculated by the state feedback controller 17.

The PWM control unit 14 calculates operation signals GSu, GSv, GSw for operating the U-, V-, and W-phase semiconductor switches of the inverter 20 based on the U-phase command voltage Vu, the V-phase command voltage Vv, and the W-phase command voltage Vw. In other words, the PWM control unit 14 generates PWM waveform signals (voltage designated value signals) GSu, GSv, and GSw to perform switching control of each switch of the inverter 20.

The operation signal GSu is a signal for operating the U-phase switch of the inverter 20. The operation signal GSv is a signal for operating the V-phase switch of the inverter 20. The operation signal GSw is a signal for operating the W-phase switch of the inverter 20. Then, the PWM control unit 14 outputs the operation signals GSu, GSv, and GSw to the inverter 20. In this manner, the controller 10 controls the inverter 20. The two-to-three phase conversion unit 13 and the PWM control unit 14 correspond to a control unit.

The three-to-two phase conversion unit 15 performs dq axis conversion of each phase current Iu to Iw into a d-axis current value Idr and a q-axis current value Iqr based on the electrical angle θr. That is, the three-to-two phase conversion unit 15 converts each of the phase currents Iu to Iw into a d-axis current value Idr and a q-axis current value Iqr, which are values on the dq coordinate system. The three-to-two phase conversion unit 15 corresponds to a conversion unit. The rotation speed w of the motor 30 is calculated by the rotation speed calculation unit 16. The rotation speed calculation unit 16 calculates the rotation speed w by differentiating the electrical angle θr.

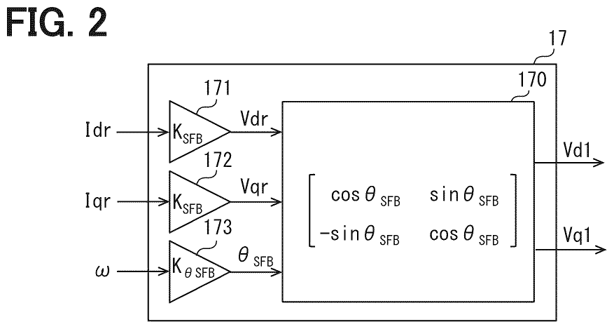

The state feedback controller 17 will be described with reference to FIG. 2. The state feedback controller 17 includes a rotation matrix calculation unit 170 and gain compensators 171 to 173. The d-axis gain compensator 171 calculates the d-axis voltage value Vdr by performing state feedback control of the d-axis current value Idr with a state feedback gain K_{SFB}. The q-axis gain compensator 172 calculates the q-axis voltage value Vqr by performing state feedback control on the q-axis current value Iqr with a state feedback gain K_{SFB}. In this manner, the state feedback controller 17 calculates the d-axis voltage value Vdr and the q-axis voltage value Vqr by performing state feedback control on the d-axis current value Idr and the q-axis current value Iqr.

The state feedback gain K_{SFB} is a value that is set in advance based on manufacturing variations, control periods, and the like. In this embodiment, as an example, the same state feedback gain K_{SFB} is used on the d-axis side and the q-axis side. However, the state feedback gain K_{SFB} may have different values on the d-axis side and the q-axis side.

The w gain compensator 173 calculates the rotation angle θ_{SFB} by multiplying the rotation speed ω by a state feedback angle gain Kθ_{SFB}. The state feedback angle gain Kθ_{SFB} is a value that is set in advance based on the characteristics of the motor 30. The characteristics of the motor 30 are parameters such as the resistance value and inductance of the motor 30. The rotation angle θ_{SFB} is an angle that correlates with the rotation speed ω of the motor 30 and is determined by the characteristics of the motor 30. In this embodiment, as an example, a rotation angle θ_{SFB} proportional to the rotation speed ω is adopted. That is, the rotation angle θ_{SFB} is a value that is proportional to the rotation speed ω. The rotation angle θ_{SFB} can also be called the rotation angle of a state feedback control system or a state feedback rotation angle.

The rotation matrix calculation unit 170 receives the d-axis voltage value Vdr, the q-axis voltage value Vqr, and the rotation angle θ_{SFB}. The rotation matrix calculation unit 170 calculates the rotation matrix shown in FIG. 2. The rotation matrix calculation unit 170 performs rotation transformation on the d-axis voltage value Vdr and the q-axis voltage value Vqr by a rotation angle θ_{SFB} (angle) using a rotation matrix to calculate a d-axis voltage correction value Vd1 and a q-axis voltage correction value Vq1. That is, the rotation matrix calculation unit 170 calculates the d-axis voltage correction value Vd1 and the q-axis voltage correction value Vq1 by rotating the d-axis voltage value Vdr and the q-axis voltage value Vqr in the opposite direction by the rotation angle θ_{SFB}. The rotation matrix calculation unit 170 can also be considered as a calculator of a state feedback control system or a phase compensator of the state feedback control system.

The controller 10 is designed in a discrete system rather than a continuous system. In the case of a discrete system, it is necessary to compensate for the interference between the d-axis and the q-axis in state feedback control. The more precisely the inter-axis interference is compensated for, the more stable the control becomes. However, there is a possibility that the calculation will become unstable due to the time required for the calculation. Therefore, the controller 10 calculates the d-axis voltage correction value Vd1 and the q-axis voltage correction value Vq1 for compensating for the inter-axis interference by the rotation matrix calculation unit 170.

As described above, the controller 10 uses a rotation matrix to perform a rotation transformation at the rotation angle θ_{SFB} that is correlated with the rotation speed ω of the motor 30 and determined by the characteristics of the motor 30, and calculates the d-axis voltage correction value Vd1 and the q-axis voltage correction value Vq1. Then, the controller 10 calculates the d-axis corrected command value Vd and the q-axis corrected command value Vq using the d-axis voltage correction value Vd1 and the q-axis voltage correction value Vq1. Furthermore, the controller 10 calculates operation signals GSu, GSv, GSw from values Vu to Vw obtained by uvw conversion of the d-axis corrected command value Vd and the q-axis corrected command value Vq, and outputs them to the inverter.

Therefore, the controller 10 can suppress instability caused by state feedback control when the control period is slow and the motor 30 is rotating at high speed. Therefore, the controller 10 can stably control the inverter 20 when the control period is slow and the rotation speed is high. Furthermore, the controller 10 can stably control the inverter 20 while suppressing harmonic ripples. It can also be said that the controller 10 can stably control the drive of the motor 30 via the inverter 20 when the control period is slow and the motor is rotating at high speed.

That is, in the drive system 100, harmonic ripples occur due to the dead time variation of the inverter 20. In the drive system 100, abnormal noise (audible noise) occurs when the harmonic ripple coincides with the resonant frequency of the cooling system. This dead time variation is a voltage disturbance. In order to suppress this voltage disturbance, it is conceivable to use state feedback control.

However, in the state feedback control, when the control period of the controller 10 is slow and the rotation speed is high, the control system may become unstable. Therefore, the controller 10 calculates the d-axis voltage correction value Vd1 and the q-axis voltage correction value Vq1 using the rotation matrix as described above, and calculates the d-axis corrected command value Vd and the q-axis corrected command value Vq using the d-axis voltage correction value Vd1 and the q-axis voltage correction value Vq1. This allows the controller 10 to stabilize the control of the inverter 20 as described above, and suppress harmonic ripples through state feedback control. The control system includes the drive system 100, the cooling fan 50, and the motor 30 that rotates the cooling fan 50. In other words, the control system can be rephrased as a cooling system.

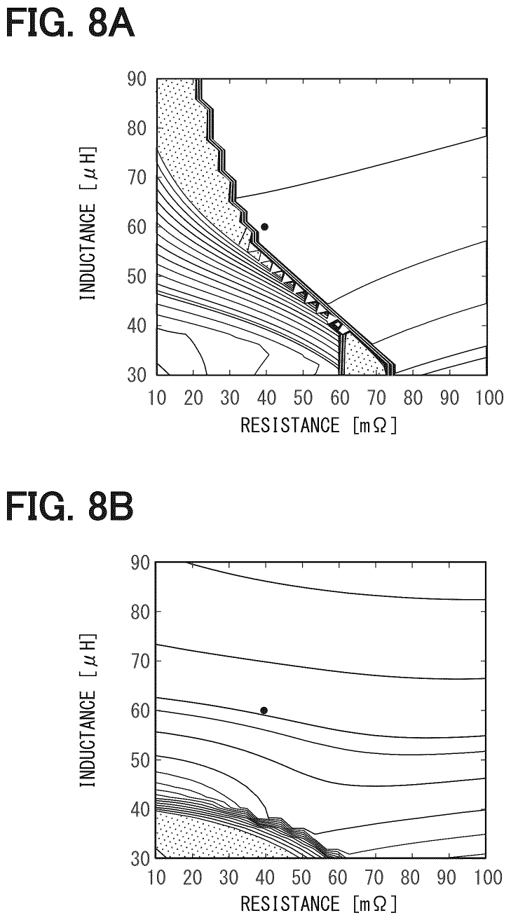

In addition, the stability of the motor 30 against parameter variations was confirmed using the contour diagram shown in FIGS. 8A and 8B. FIG. 8A shows the results for a comparative controller that does not use a rotation matrix. FIG. 8B shows the results for the controller 10 using a rotation matrix. In addition, in FIGS. 8A an 8B, the unstable regions are hatched. The black dots in FIGS. 8A and 8B indicate nominal parameters (design values). The parameters of the motor 30 include the resistance value and the inductance.

As shown in FIG. 8A, in the comparative control unit, the unstable region is close to the nominal parameters, and the control system is easily destabilized by parameter fluctuations. On the other hand, as shown in FIG. 8B, in the controller 10, the unstable region is far from the nominal parameters, and the control system can be stabilized. In other words, the control system of the controller 10 is unlikely to become unstable even if the parameters fluctuate.

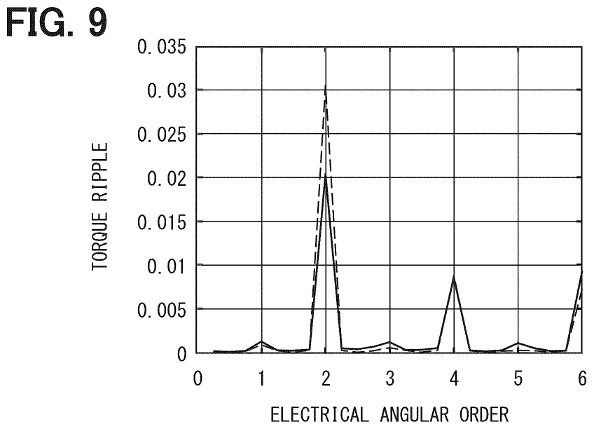

Furthermore, the above-mentioned abnormal noise is caused by the secondary ripple component of the electrical angle. Therefore, the effect was confirmed by torque ripple as shown in FIG. 9. FIG. 9 is a graph showing the torque ripple reduction effect. More specifically, FIG. 9 shows the results of a simulation showing the relationship between the electrical angle order and the torque ripple. The solid line in FIG. 9 is a simulation result for the controller 10 equipped with the state feedback controller 17. On the other hand, the solid line in FIG. 9 represents the simulation results for a comparative controller that does not include the state feedback controller 17. As shown in FIG. 9, it was confirmed that the controller 10 can reduce the torque ripple of the electrical angle second order by approximately 33%.

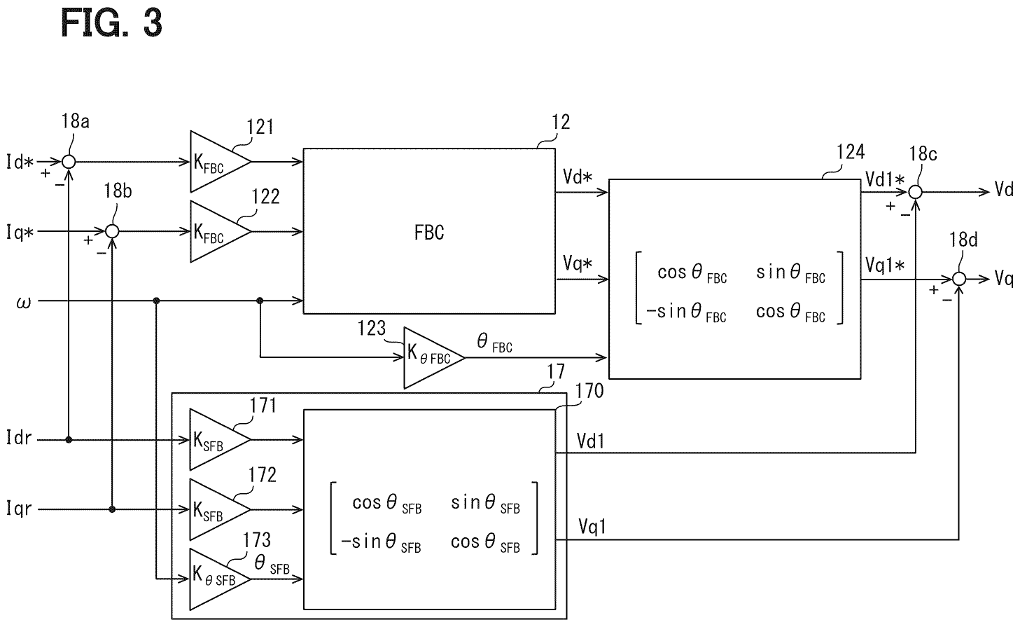

As in a modified example shown in FIG. 3, the controller 10 may be provided with a rotation matrix calculation unit 124 on the output side of the feedback controller 12. The rotation matrix calculation unit 124 can also be said to be a calculator of a feedback control system or a phase compensator of a feedback control system. The rotation matrix calculation unit 124 corresponds to a correlation value calculation unit.

The rotation matrix calculation unit 124 receives the d-axis voltage command value Vd*, the q-axis voltage command value Vq*, and the rotation angle θ_{FBC}. The rotation matrix calculation unit 124 calculates the rotation matrix shown in FIG. 3. The rotation angle θ_{FBC} is calculated by the w gain compensator 123. The rotation speed ω is input to the w gain compensator 123, and a feedback angle gain Kθ_{FBC} is set.

The rotation matrix calculation unit 170 performs a rotational conversion on the d-axis voltage command value Vd* and the q-axis voltage command value Vq* at a rotation angle θ_{FBC} using a rotation matrix to calculate a d-axis correlation value Vd1* that is correlated with the d-axis voltage command value Vd* and a q-axis correlation value Vq1* that is correlated with the q-axis voltage command value Vq*. That is, the rotation matrix calculation unit 170 calculates the d-axis correlation value Vd1* and the q-axis correlation value Vq1* by rotating the d-axis voltage command value Vd* and the q-axis voltage command value Vq* in the opposite direction by the rotation angle θ_{FBC}.

In the configuration of the modified example, the second d-axis calculator 18c calculates a value obtained by subtracting the d-axis voltage correction value Vd1 from the d-axis correlation value Vd1* as the d-axis corrected command value Vd. The second q-axis calculator 18d calculates a value obtained by subtracting the q-axis voltage correction value Vq1 from the q-axis correlation value Vq1* as the q-axis corrected command value Vq.

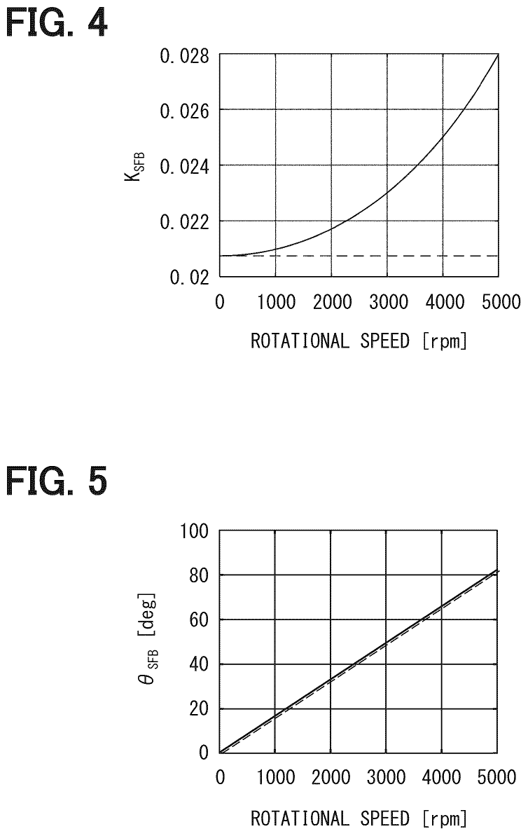

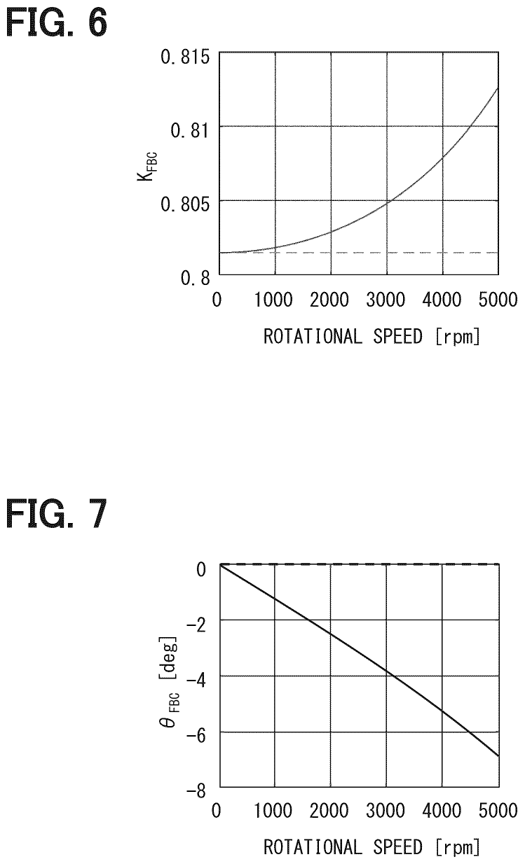

FIGS. 4, 5, 6, and 7 show the rotation speed characteristics of the state feedback gain K_{SFB}, the rotation angle θ_{SFB}, the feedback gain K_{FBC}, and the rotation angle θ_{FBC}. In each drawing, the theoretical values are shown by solid lines. The controller 10 according to the modified example performs calculation processing using theoretical values to control the inverter 20. Therefore, the controller 10 according to the modified example can appropriately control the inverter 20.

However, the processing load of the controller 10 of the modified example increases by using the theoretical values shown in FIGS. 4, 5, 6, and 7. Therefore, in the above embodiment, as shown by the dashed lines in FIGS. 4, 5, 6 and 7, the state feedback gain K_{SFB}, the feedback gain K_{FBC}, and the rotation angle θ_{FBC} are approximated as being constant values, and the rotation angle θ_{SFB} is proportional to the rotation speed ω. This allows the controller 10 of the above embodiment to have a lower processing load than the modified example.

However, the present disclosure is not only limited to the above example. It is also conceivable that the theoretical value of the rotation angle θ_{SFB} changes linearly depending on the range of the rotation speed ω. In this case, the rotation angle θ_{SFB} is a value that correlates with the rotation speed ω, and is determined by changing the slope and intercept of a linear function according to the rotation speed ω.

The preferred embodiment of the present disclosure has been described above. However, the present disclosure is not limited to the above embodiment. Various modifications may be made without departing from the scope and spirit of the present disclosure.

Although the present disclosure has been described in accordance with the embodiments, it is understood that the present disclosure is not limited to the embodiments or the structures. The present disclosure encompasses various modifications and variations within the scope of equivalents. In addition, while various combinations and modes are described in the present disclosure, other combinations and modes including only one element, more elements, or less elements therein are also within the scope and spirit of the present disclosure.

What is claimed is:

1. A controller for a drive system, the drive system configured to convert DC power of a DC power supply into three-phase AC power through an inverter and supply the three-phase AC power to a rotating electric machine, the controller comprising:
a command value output unit configured to output a d-axis current command value and a q-axis current command value;
a conversion unit configured to convert phase currents into a d-axis current value and a q-axis current value through dq-axis transformation, the phase currents being currents flowing through respective phases of the rotating electric machine;
a feedback controller configured to calculate a d-axis voltage command value and a q-axis voltage command value by performing
feedback control based on the d-axis current value and the d-axis current command value, and
feedback control based on the q-axis current value and the q-axis current command value;
a state feedback controller configured to calculate a d-axis voltage correction value and a q-axis voltage correction value by performing
state feedback control of the d-axis current value and the q-axis current value to acquire a d-axis voltage value and a q-axis voltage value, and
rotation conversion of the d-axis voltage value and the q-axis voltage value at an angle by using a rotation matrix, the angle being correlated to a rotational speed of the rotating electric machine and determined based on a characteristic of the rotating electric machine; and
a control unit configured to output to the inverter a value as a voltage command that is calculated through vector control in which uvw conversion of a d-axis corrected command value and a q-axis corrected command value is performed, the d-axis corrected command value being a value obtained by subtracting the d-axis voltage correction value from either the d-axis voltage command value or a correlated value correlated to the d-axis voltage command value, the q-axis corrected command value being a value obtained by subtracting the q-axis voltage correction value from either the q-axis voltage command value or a correlated value correlated to the q-axis voltage command value.

2. The controller according to claim 1, further comprising:
a correlated value calculation unit configured to calculate the correlated value correlated to the d-axis voltage command value and the correlated value correlated to the q-axis voltage command value by performing rotation conversion of the d-axis voltage command value and the q-axis voltage command value at an angle by using a rotation matrix, the angle being correlated to the rotational speed of the rotating electric machine and determined based on a characteristic of the feedback controller and a characteristic of the state feedback controller.

3. The controller according to claim 1, wherein
the angle determined based on the characteristic of the rotating electric machine is proportional to the rotational speed of the rotating electric machine.

4. A method for a drive system, the drive system configured to convert DC power of a DC power supply into three-phase AC power through an inverter and supply the three-phase AC power to a rotating electric machine, the method comprising:
outputting a d-axis current command value and a q-axis current command value;
converting phase currents into a d-axis current value and a q-axis current value through dq-axis transformation, the phase currents being currents flowing through respective phases of the rotating electric machine;
calculating a d-axis voltage command value and a q-axis voltage command value by performing
feedback control based on the d-axis current value and the d-axis current command value, and
feedback control based on the q-axis current value and the q-axis current command value;
calculating a d-axis voltage correction value and a q-axis voltage correction value by performing
state feedback control of the d-axis current value and the q-axis current value to acquire a d-axis voltage value and a q-axis voltage value, and
rotation conversion of the d-axis voltage value and the q-axis voltage value at an angle by using a rotation matrix, the angle being correlated to a rotational speed of the rotating electric machine and determined based on a characteristic of the rotating electric machine; and
outputting to the inverter a value as a voltage command that is calculated through vector control in which uvw conversion of a d-axis corrected command value and a q-axis corrected command value is performed, the d-axis corrected command value being a value obtained by subtracting the d-axis voltage correction value from either the d-axis voltage command value or a correlated value correlated to the d-axis voltage command value, the q-axis corrected command value being a value obtained by subtracting the q-axis voltage correction value from either the q-axis voltage command value or a correlated value correlated to the q-axis voltage command value.

5. A non-transitory computer readable medium for a drive system, the drive system configured to convert DC power of a DC power supply into three-phase AC power through an inverter and supply the three-phase AC power to a rotating electric machine, the non-transitory computer readable medium storing a computer program comprising instructions configured to, when executed by at least one processor, cause the at least one processor to:
output a d-axis current command value and a q-axis current command value;
convert phase currents into a d-axis current value and a q-axis current value through dq-axis transformation, the phase currents being currents flowing through respective phases of the rotating electric machine;
calculate a d-axis voltage command value and a q-axis voltage command value by performing
feedback control based on the d-axis current value and the d-axis current command value, and
feedback control based on the q-axis current value and the q-axis current command value;
calculate a d-axis voltage correction value and a q-axis voltage correction value by performing
state feedback control of the d-axis current value and the q-axis current value to acquire a d-axis voltage value and a q-axis voltage value, and
rotation conversion of the d-axis voltage value and the q-axis voltage value at an angle by using a rotation matrix, the angle being correlated to a rotational speed of the rotating electric machine and determined based on a characteristic of the rotating electric machine; and
output to the inverter a value as a voltage command that is calculated through vector control in which uvw conversion of a d-axis corrected command value and a q-axis corrected command value is performed, the d-axis corrected command value being a value obtained by subtracting the d-axis voltage correction value from either the d-axis voltage command value or a correlated value correlated to the d-axis voltage command value, the q-axis corrected command value being a value obtained by subtracting the q-axis voltage correction value from either the q-axis voltage command value or a correlated value correlated to the q-axis voltage command value.
